(19) United States
(12) Patent Application Publication
(10) Pub. No.: US 2024/0301110 A1
(43) Pub. Date: Sep. 12, 2024

(54) FLUOROCHEMICAL-FREE PVOH POLMERS AND FORMULATIONS FOR CELLULOSIC MATERIALS

(71) Applicant: Sekisui Specialty Chemicals America, LLC, Pasadena, TX (US)

(72) Inventors: Vinh Nguyen, Pasadena, TX (US); Richard Vicari, Pasadena, TX (US); David B. Wurm, Pasadena, TX (US); George Shitera, Pasadena, TX (US)

(73) Assignee: Sekisui Specialty Chemicals America, LLC, Pasadena, TX (US)

(21) Appl. No.: 18/583,614

(22) Filed: Feb. 21, 2024

Related U.S. Application Data
(60) Provisional application No. 63/486,203, filed on Feb. 21, 2023.

(51) Int. Cl. C08F 261/04

(52) U.S. Cl. CPC C08F 261/04

(57) ABSTRACT

A formulation for cellulosic materials comprises a polyvinyl alcohol terpolymer comprising a polyvinyl alcohol modified with about 1 mol % to about 10 mol % of a hydrophilic comonomer, and with about 1 mol % to about 5 mol % of a hydrophobic comonomer, and having a degree of hydrolysis of about 92% to about 98%.

### CROSS-REFERENCE TO RELATED APPLICATIONS

None.

### BACKGROUND

The present disclosure relates in general to polyvinyl alcohol (PVOH) polymers and formulations, and more particularly, to fluorochemical-free PVOH polymers and formulations for paper and paper coatings.

All of the subject matter discussed in the Background section is not necessarily prior art and should not be assumed to be prior art merely as a result of its discussion in the Background section. Along these lines, any recognition of problems in the prior art discussed in the Background section or associated with such subject matter should not be treated as prior art unless expressly stated to be prior art. Instead, the discussion of any subject matter in the Background section should be treated as part of the inventor's approach to the particular problem, which in and of itself may also be inventive.

PVOH is a common water-soluble polymer used in numerous industrial applications including papermaking, protective coatings, adhesives, thickening agents, and textiles. When used in papermaking, PVOH is often used as a binder to provide both sheet physical strength and surface strength to paper or paperboard, including products containing recycled fiber. As a paper coating agent, PVOH polymers and their formulations may also improve barrier performance against organic solvents, water, and oil and grease for food packaging.

Fluorochemicals have traditionally been used to provide oil and grease resistance for most food packaging applications because they perform well in this regard. However, common classes of fluorochemicals, such as perfluoroalkyl substances, or PFASs, tend to persist in the environment due to their stable chemical bonds and have been linked to certain cancers, kidney and liver damage among other detrimental health effects. Accordingly, governmental agencies from a number of European countries as well as the US have announced a plan to restrict all PFAS chemicals by 2030, including many US states announcing legislation to ban PFAS within the next few years.

Therefore, there is a strong need to develop environmentally friendly and healthy alternatives to fluorochemical-based chemistries in the paper and package industry. Although PVOH is an environmentally safe biodegradable polymer, it has not traditionally performed as well as fluorochemical-based chemistries in terms of barrier performance when considering cost-in-use, and in terms of water resistance, is thought to perform poorly due to its hydrophilic and water-soluble nature. There is thus a need to develop improved PVOH-based polymers and formulations for paper that satisfy the requirements of oil and grease resistance, water resistance, and others.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In one aspect, a formulation for cellulosic materials comprises a polyvinyl alcohol terpolymer comprising a polyvinyl alcohol modified with about 1 mol % to about 10 mol % of a hydrophilic comonomer, and with about 1 mol % to about 5 mol % of a hydrophobic comonomer, and having a degree of hydrolysis of about 92% to about 98%.

Other aspects and advantages of the claimed subject matter will be apparent from the following description and the appended claims.

### BRIEF DESCRIPTION OF THE SEVERAL VIEWS OF THE DRAWINGS

FIG. 1A is a graph of solution viscosity ranges according to an aspect of the present disclosure.

FIG. 1B is a graph of viscosity versus solution solids according to an aspect of the present disclosure.

FIG. 2A is a graph of coat weights for single coating according to an aspect of the present disclosure.

FIG. 2B is a graph of coat weights for double coating according to an aspect of the present disclosure.

FIG. 2C is a graph of coat weight as a function of solution solids for target viscosities according to an aspect of the present disclosure.

FIG. 3A is a graph of gurley porosity for single coating according to an aspect of the present disclosure.

FIG. 3B is a graph of gurley porosity for double coating according to an aspect of the present disclosure.

FIG. 3C is a graph of gurly porosity normalized for a viscosity target according to an aspect of the present disclosure.

FIG. 4A is a graph of Cobb value for single coating according to an aspect of the present disclosure.

FIG. 4B is a graph of Cobb value for double coating according to an aspect of the present disclosure.

FIG. 4C is a graph of Cobb value normalized for a viscosity target according to an aspect of the present disclosure.

FIG. 5A is a graph of Cobb/Mazola results for single coating according to an aspect of the present disclosure.

FIG. 5B is a graph of Cobb/Mazola results for double coating according to an aspect of the present disclosure.

FIG. 5C is a graph of Cobb/Mazola results normalized for a viscosity target according to an aspect of the present disclosure.

FIG. 6A is a graph of 3M Kit Test results for single coating according to an aspect of the present disclosure.

FIG. 6B is a graph of 3M Kit Test results for double coating according to an aspect of the present disclosure.

FIG. 6C is a graph of 3M Kit Test results normalized for a viscosity target according to an aspect of the present disclosure.

### DETAILED DESCRIPTION

The present disclosure provides improved formulations for cellulosic materials utilizing polyvinyl alcohol (PVOH) terpolymers comprising both hydrophilic and hydrophobic comonomers, and which were surprisingly found to exhibit strong oil and great resistance among other desirable properties despite being fluorochemical free.

“Cellulosic materials” may refer to any substance made from cellulose or deriving from cellulose or cellulose fibers, and which may be coated or formulated with the formulations of the present disclosure, including but not limited to paper, paperboard, and cardboard such as used for printing and packaging.

PVOH terpolymers useful in embodiments disclosed herein may be formed via the copolymerization of a vinyl ester monomer and one or more selected hydrophilic comonomers and hydrophobic comonomers.

Suitable hydrophilic comonomers may comprise sulfonic acid, vinyl lactam, carboxylate, vinyl amine, and vinyl amide, as non-limiting examples.

Examples of suitable hydrophilic sulfonic acid comonomers containing sulfonic acid groups may include but are not limited to vinyl sulfonic acid, allyl sulfonic acid, ethylene sulfonic acid, 2-acrylamido-1-methylpropanesulfonic acid, 2-acrylamido-2-methylpropanesulfonic acid (AMPS), 2-methacrylamido-2-methylpropanesulfonic acid, 2-sulfoethyl acrylate, and salts thereof, among others. In some embodiments, the sulfonic acid containing comonomer is 2-acrylamido-2-methylpropanesulfonic acid (AMPS) or salt thereof.

Examples of suitable vinyl lactam hydrophilic comonomers may include compounds having a polymerizable carbon-carbon double bond and a pyrrolidone ring substituent group represented by the following formula:

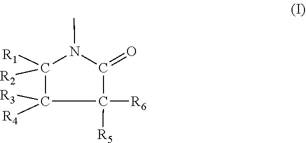

wherein R1, R2, R3, R4, R5 and R6 are each individually selected from a hydrogen atom or an alkyl group, such as an alkyl group having 1 to 8 carbon atoms. Examples of the group represented by the general formula (I) are 2-oxopyrrolidin-1-yl group, 3-propyl-2-oxopyrrolidin-1-yl group, 5-methyl-2-oxopyrrolidin-1-yl group, 5,5-dimethyl-2-oxopyrrolidin-1-yl group, 3,5-dimethyl-2-oxopyrrolidin-1-yl group, and the like. The carbon-carbon double bond contained in the pyrrolidone comonomer may include vinyl, allyl, styryl, acryloxy, methacryloxy, vinyloxy, allyloxyl, and other groups, that are copolymerizable with the above noted vinyl esters of aliphatic acids and have a high alkali resistance at the time of hydrolysis to form the vinyl alcohol terpolymer. Examples of the pyrrolidone comonomers may include N-vinyl-2-pyrrolidone (NVP), N-vinyl-3-propyl-2-pyrrolidone, N-vinyl-5-methyl-2-pyrrolidone, N-vinyl-5,5-dimethyl-2-pyrrolidone, N-vinyl-3,5-dimethyl-2-pyrrolidone, and N-allyl-2-pyrrolidone, among others.

Examples of suitable hydrophilic carboxylate-containing comonomers include those derived from carboxylic acid vinyl monomers and their esters. Such carboxylate-containing comonomers include but are not limited to acrylic acid, crotonic acid, methyl acrylate (MA), methacrylic acid, methyl methacrylate, maleic acid, itaconic acid, dimethyl itaconate and fumaric acid.

Examples of suitable hydrophilic comonomers may also comprise vinyl amine or vinyl amide, including but not limited to vinyl acetamides, vinyl formamides, etc.

Suitable hydrophobic comonomers may comprise vinyl esters of branched tertiary monocarboxylic acids, which may include vinyl esters of versatic acid commercially available under the mark VeoVa from the Shell Chemical Company or sold as EXXAR neo vinyl esters by the ExxonMobil Chemical Company. More preferably, suitable hydrophobic comonomers may comprise vinyl neodecanoate, such as under the trade name VeoVa 10 containing 10 carbon atoms by the Shell Chemical Company, however, VeoVa 9 containing 9 carbon atoms may also work, such as vinyl neononanoate.

PVOH may be modified with combinations of one or more of the above-described hydrophobic and hydrophilic comonomers through copolymerization techniques such as bulk polymerization, solution polymerization, emulsion polymerization, suspension polymerization, and the like. The terpolymer thus obtained may be saponified, and the resulting PVOH terpolymer may have a degree of hydrolysis measured by JIS K6726 in the range from about 92% to about 98%.

Preferably, the PVOH is modified with about 1 mol % to about 10 mol % of a suitable hydrophilic comonomer, and with about 1 mol % to about 5 mol % of a suitable hydrophobic comonomer, including the examples described above, to form a polyvinyl alcohol terpolymer. More preferably, the PVOH may be modified with about 2 mol % to about 6 mol % of a hydrophilic comonomer, and about 1 mol % to about 4 mol % of a hydrophobic comonomer.

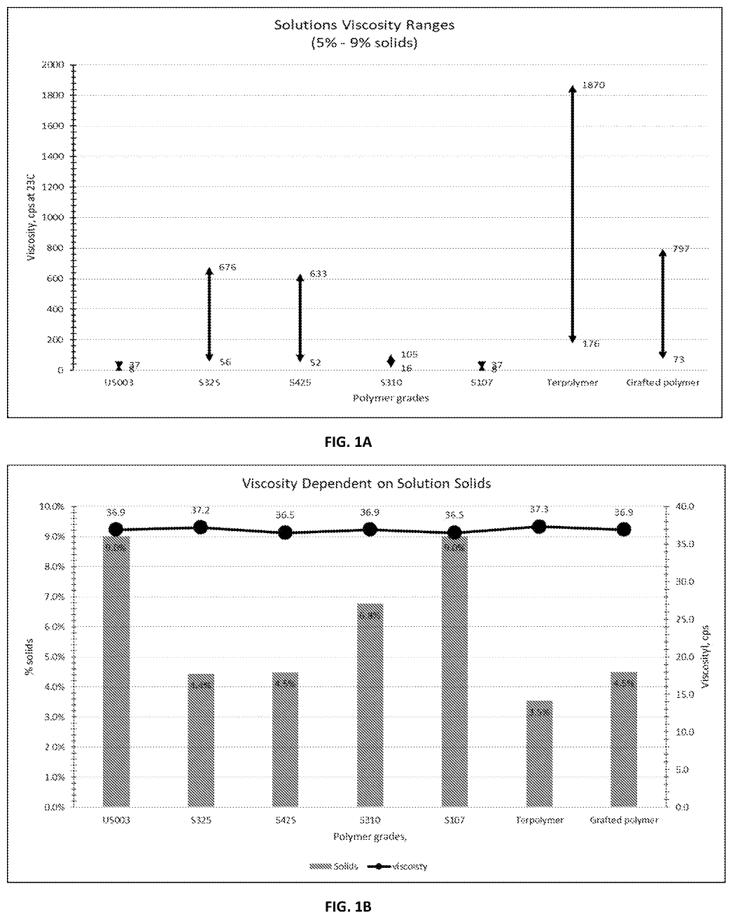

The terpolymers according to embodiments herein may have a relative molecular weight indicated by a solution viscosity that can be tailored in the range from about 4 to about 1000 cP, in some embodiments; in the range from about 50 to about 800 cP in other embodiments. The solution viscosity may be normalized, for example, by changing the percent solids in the solution, as described further below and in reference to FIG. 1A and FIG. 1B, and taking into account the structural characteristics of the polymers such as functional groups, chain shape, co-monomer content, etc. The solution viscosity is determined on a solution solid of the polymer in water, measured on a Brookfield viscometer at 20-23 C by JIS K6726.

The PVOH terpolymers according to embodiments herein may also be grafted to a sizing agent. “Sizing agent” refers to a substance that is used to facilitate surface strength, printability and/or water resistance of cellulosic materials to which they are applied, and may include either surface or internal sizing agents. Sizing agents may comprise modified starches or other hydrocolloids, or acrylic co-polymers exhibiting amphiphilic properties. Preferably, the sizing agent may comprise alkyl ketene dimer (“AKD”) or alkenyl succinic anhydride (“ASA”). The polyvinyl alcohol terpolymers may be grafted with about 0.25 mol % to about 2.0 mol % of the sizing agent.

Grafted polyvinyl alcohol terpolymers may be formed by a batch process according to the detailed method described further below.

As noted above, polyvinyl alcohol terpolymers useful in embodiments disclosed herein may be formed via the copolymerization of a vinyl ester monomer and one or more selected comonomers via bulk polymerization, solution polymerization, emulsion polymerization, suspension polymerization, and the like. Reaction conditions may vary based upon the monomer and comonomers being used, and the reactions may be carried out in a single stage or multiple stages.

A free radical yielding polymerization initiator may be utilized for the copolymerization reactions and may be, for example, 2-ethylhexyl peroxydicarbonate (Trigonox EHP), 2,2′-azobisisobutylronitrile (AIBN), t-butyl peroxyneodecanoate (Trigonox 23), bis(4-t-butylcyclohexyl) peroxydicarbonate, di-n-propyl peroxydicarbonate, di-n-butyl peroxydicarbonate, di-acetyl peroxydicarbonate, di-s-butyl peroxydicarbonate. Essentially any initiator able to generate free radicals can be used. The amount of polymerization initiator fed to the reaction zone(s) may be, for example, about 0.0001 to about 1 wt. % based on the total amount of reactants being added.

Optionally, acetaldehyde (AcH) as a chain transfer agent can be continuously fed to the reaction zone(s) with the other components. The amount of AcH may, for example, be up to about 0.2 wt. % based on the total amount of reactants being added.

A solvent for the comonomers, the polymerization initiator and the copolymer being formed in the reaction zones is generally employed in the process. Suitable solvents are, for example, methanol, ethanol, and propanol. The amount of solvent fed to the reaction zone(s) may be, for example, about 10 to about 40 wt. % based on the total amount of reactants being added.

The amount of a first hydrophilic comonomer and second hydrophobic comonomer fed to the reaction zone(s) is, for example, about 0.1 to about 30 wt %, based on the total amount of reactants being added, so as to achieve the compositional content of the terpolymer as described earlier. Monomer, first comonomer, and second comonomer may be added at to the reactor for reaction together, in some embodiments, or may be added stage-wise. For example, a vinyl ester monomer, such as vinyl acetate, may be added to the reactor and reaction initiated and continued for a period of time before the first comonomer and second comonomer are added to the reactor.

The average residence time of the reactants in the reaction zone(s) may be, for example, in the range of about 30 to about 360 minutes, such as in the range from about 30 to about 240 minutes or from about 60 to about 180 minutes. Reaction temperatures may be, for example, from about 55° C. to about 85° C., such as from about 60° C. to about 80° C. The pressure in the reaction zone(s) may be at ambient pressure (about 0 bar gauge (about 0 psig)) in some embodiments. In other embodiments, pressure in the reaction zones may be slightly above atmospheric pressure, for example, in the range from about 0.1 to 2.1 barg (about 1 to about 30 psig), such as from about 0.2 to about 1.1 barg (about 3 to about 15 psig.

The residence times and temperatures in the reaction zone(s) are generally sufficient to result in the polymerization of substantially all of the first and second comonomers fed to the system, although a small percentage of vinyl ester added to the system may remain unpolymerized.

In carrying out the saponification of the resulting terpolymers, the reaction effluent may, for example, be fed to a stripping column to remove the more volatile components such as unreacted vinyl ester monomer. The resulting “paste” is then mixed with an aqueous solution of a strong base such as sodium hydroxide, e.g., containing about 10 to about 50 wt. % of sodium hydroxide to provide base at a caustic mole ratio (CMR, ratio of moles of base to moles of acetate in the copolymer) of about 0.01 to about 0.1. Optionally, an amount of a volatile alcohol, e.g., methanol, is also added to reduce the solids content in the paste to about 30 to about 65 wt. %. The resulting mass is then allowed to react at a temperature from about room temperature (RT, about 22° C.) to about 50° C. for a period of about 5 minutes to about 24 hours to obtain a percent hydrolysis of the acetate groups in the copolymer to hydroxyl groups in the range of about 60 to about 99+%.

### EXPERIMENTAL METHODS AND EXAMPLES

The sample modified PVOH resins including terpolymers and grafted terpolymers represented in TABLE 1 and TABLE 2 below, respectively, were produced according to the methods described further below. In addition to the lab-prepared samples, commercially produced resins were also tested for comparison to embodiments herein. Commercial resins tested included Ultiloc 5003 (PVOH/Vinyl Amine Copolymer), as well as PVOH homopolymers including Selvol 325 (Sample S325), Selvol 425 (Sample S425), Selvol 310 (Sample S310), Selvol 107 (Sample S107), all available from Sekisui Specialty Chemicals America LLC. The degree of hydrolysis for these PVOH homopolymers ranged between about 96 to about 98.8 mol %.

TABLE 1

| | | 4% | Degree of | | | | |
|---|---|---|---|---|---|---|---|
| Terpolymer | Conversion | Viscosity, | Hydrolysis, | AMPS, | Veova10, | OAc, | OH, |
| Samples | % | cps | mol % | mol % | mol % | mol % | mol % |
| 1 | 70.3 | 109.5 | 95.35 | 2.25 | 1.89 | 3.24 | 92.62 |
| 2 | 77.7 | 62.3 | 96 | 2.24 | 3.29 | 2.22 | 92.25 |
| 3 | 82.6 | 57.4 | 92.5 | 4.57 | 3.84 | 5.42 | 86.17 |

TABLE 2

| Grafted | | | | | |
|---|---|---|---|---|---|
| Terpolymer | AMPS, | Veova10, | OAc, | OH, | AKD, |
| Samples | mol % | mol % | mol % | mol % | mol % |
| 1 | 4.07 | 3.84 | 5.42 | 86.17 | 0.5 |
| 2 | 3.73 | 4.02 | 5.39 | 82.52 | 4.34 |
| 3 | 3.77 | 4.18 | 5.39 | 80.54 | 6.12 |

To a 5 L jacketed reactor fitted with a condenser, mechanical stirrer and feed inlets was added an initial charge of vinyl acetate 1415.54 g, AMPS 10 g (50% aqueous solution) and methanol 200 g. The reactor was heated to 65° C. while stirring at 150 rpm. When the internal temperature reached 65° C. the initiator feed solution (Trigonox EHP, 1.67 g, MeOH, 72.22 g) was started at a feed rate of 0.25 g/min. After 30 minutes the delay feeds, AMPS 352.82 g, Veova10 35.05 g and MeOH 61.11 g were started at 1.307 g/min, 0.13 g/min and 0.23 g/min, respectively. The reaction was allowed to continue at 65° C. for 360 minutes, at this time the delay and initiator feeds were stopped. The polymerization continued for 60 minutes upon which the reactor was cooled down. The results of the polymerization are shown in TABLE 1.

The resulting polymer paste solution was fed to a stripping column where methanol vapor was introduced to remove unreacted vinyl acetate. Afterwards solids were adjusted to 35 wt % with methanol. Sodium hydroxide (NaOH, 50% aq) was mixed with methanol to produce a 10 wt % solution. This was mixed into the polymer solution so that the mole ratio of NaOH and paste was 0.02. The mixture was put in a 40° C. water bath for 2 hours, and subsequently the saponified terpolymer was ground and dried in an 80° C. oven for 1.5 hours. The composition of each terpolymer sample was analyzed using NMR to generate the results of TABLE 1 above.

AKD was grafted to each sample terpolymer of TABLE 1 as follows. An agitator, thermometer, Glas-col heating mantle with J-KEM Scientific controller and cooking vessel were prepared. Cooking vessel was filled with unheated water. Agitator was turned on to allow for the surface of the water to move vigorously. A 50% of AKD portion and 100% terpolymer were added to vessel. The vessel was heated until the inner temperature reached 60° C., remaining portion of AKD was added and reactor temperature was brought to 85° C.-90° C. After 30-60 minutes at temperature, the heat was turned off and mixing continued until the inner temperature dropped to 40° C. The solids were adjusted to the target viscosity range with water. Anti-bacterial agent was added for long term storage of product. The composition of each grafted terpolymer sample was analyzed using NMR to generate the results of TABLE 2 above.

The reaction of a sizing agent, such as AKD, to a PVOH terpolymer modified with both hydrophilic and hydrophobic groups, such as AMPS and Veova 10, can be described by the following reaction to produce a 3-Keto ester-bound form of the grafted terpolymer.

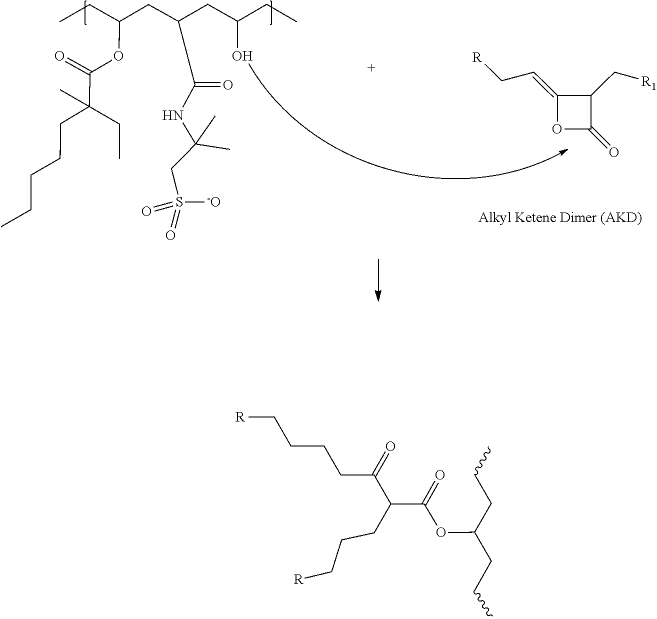

### Paper Coating, Coat Weights & Viscosity

Coating solutions of Terpolymer 3 and Grafted Terpolymer 3 (TABLES 1 and 2) and comparative commercial samples were prepared at 5%, 7% and 9% solids content. Viscosity was measured using a Brookfield Viscometer at 23° C. with spindles #18 or 31. Solutions solids were then re-adjusted to targeted viscosity ranges for further testing as described below. The solution viscosity ranges for each sample terpolymer and comparative example are shown in FIG. 1A for 5-9% solids, and the relationship between % solids versus viscosity is shown in FIG. 1B, showing that viscosity is dependent on solution solids content.

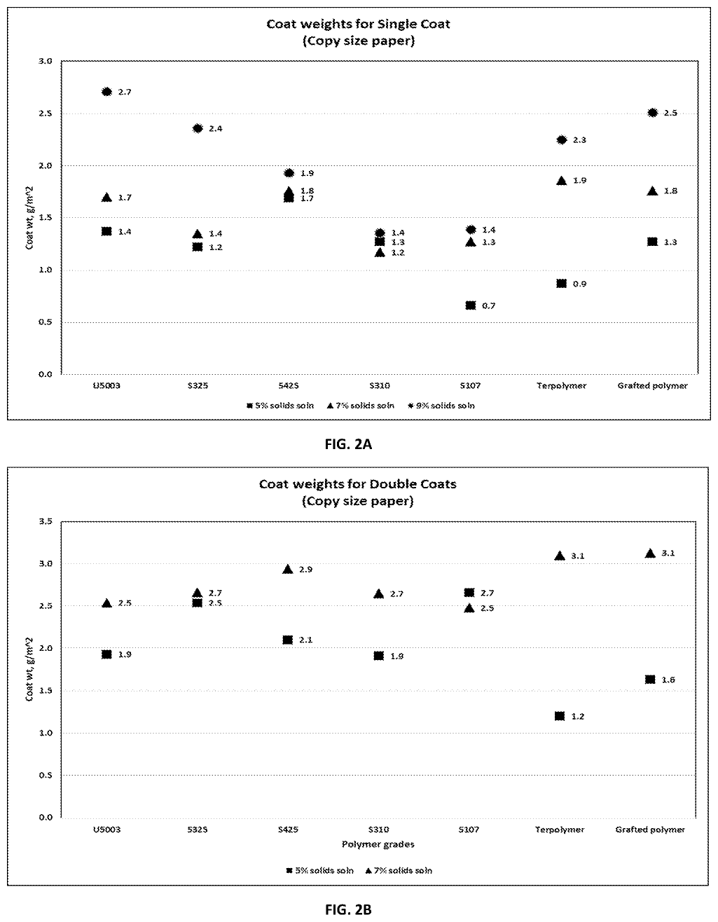

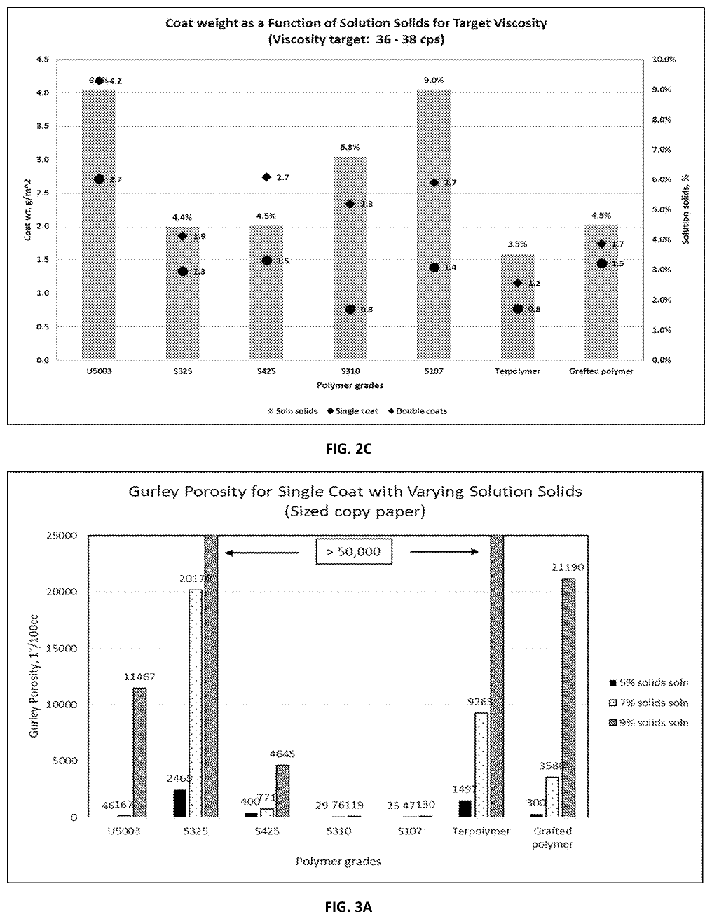

11 inch (27.9 cm) by 8.5 inch (21.6 cm) sheets of sized copy paper were then prepared for coating using a multi-coater machine, made by RK, model K 303 Multicoater. Standard size copy paper was 20 lbs. weight basis or 75 g/m² and 92 whiteness value. Consistent and uniform coat weights were made with a target range of less than 5 grams per meter squared, more preferably about 2 to about 5 grams per meter squared (gsm). Each sample and comparative solution as described above was coated onto multiple sheets and the coat weight was measured as an average of six samples taken from those sheets. Both single and double wet coats were made for each sample and comparative example and for each solids content. The results of the single coat are shown in FIG. 2A, and the double coat results are shown in FIG. 2B. FIG. 2C shows the coat weight as a function of solution solids for an example normalized target viscosity of about 36 to about 38 cP. As can be seen, higher solids and/or multiple coating layers leads to higher coat weights. Depending on the needs and target specification for the particular cellulosic materials, coat weights and viscosities may be flexibly adjusted for each formulation including the terpolymer and grafted terpolymer samples to achieve the target coat weight of about 2 to about 5 gsm.

### Gurley Porosity

Coating solutions of the terpolymer and grafted terpolymer samples and comparative commercial samples described above were measured using the Gurley Densometer Test Method to assess porosity. A Gurley densometer, made by Genuine Gurley, 4340 Automatic Densometer was used for the test method, which is described as follows according to TAPPI T-460 method, Air resistance of paper (Gurley Method).

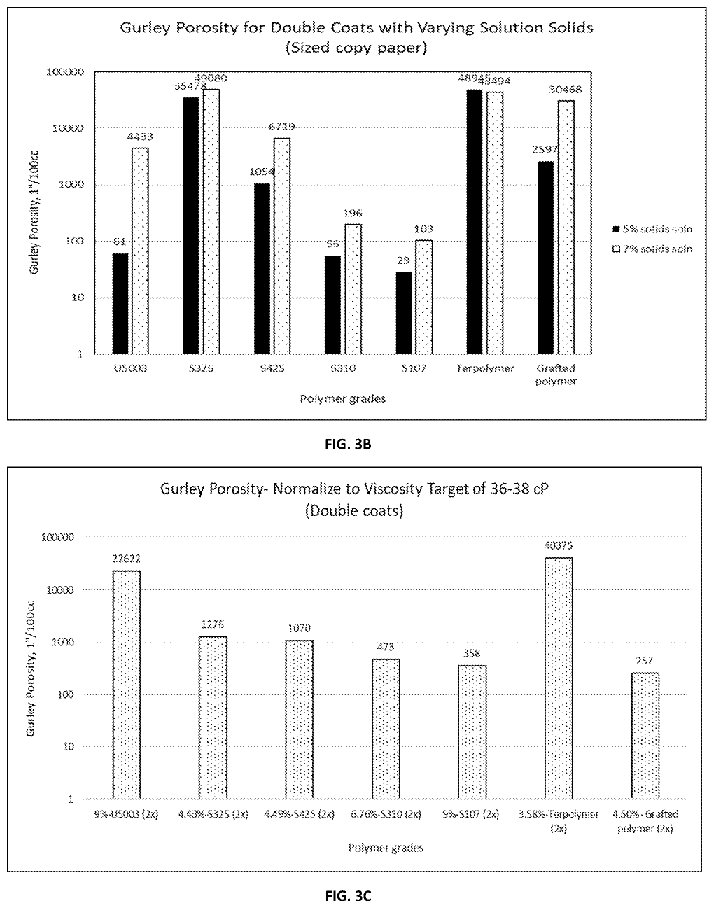

The results of the Gurley Densometer Test Method are shown with reference to FIGS. 3A, 3B and 3C. FIG. 3A shows the gurley porosity for a single coating of the terpolymer sample and comparative formulations with the varying solution solids contents of 5%, 7%, and 9%, whereas FIG. 3B shows the gurley porosity for a double coating targeted to coat weight of about 2 to about 5 gsm. FIG. 3C shows the results of gurley porosity measurements on the samples and comparative examples where the double-coat formulations have been normalized to a viscosity target of 36-38 cP by adjusting solution solids, which are listed next to each sample name along the x axis of the figure.

As can be appreciated, higher molecular weight and coat weights generally result in lower porosity. Depending on the particular needs of the cellulosic materials and application, low or high porosity may be desirable. For paper coatings, such as for food packaging, low porosity is generally desired. As shown with reference to FIG. 3C, for example, the grafted terpolymer sample performed comparatively better than the terpolymer alone or the commercial PVOH comparative examples.

Accordingly, the PVOH terpolymers and grafted terpolymers of the present disclosure may have a porosity value that is customizable in any range, preferably about 10 to about 500,000, most preferably between about 5 to about 300,000 according to the Gurley Densometer Test Method when normalized to a solution viscosity of about 36 to about 38 cP and a coat weight of about 2 to about 5 gsm.

### Cobb Values—Water Absorptiveness

Coating solutions of the terpolymer and grafted terpolymer samples and comparative commercial samples described above were measured using the Cobb Test Method to assess water absorptiveness. A water absorption apparatus, made by Testing Machine Inc. model 61-04 Cobb Sizing Tester was used for the test method, which is described as follows. TAPPI T 441, Water absorptiveness of sized (non-bibulous) paper, paperboard, and corrugated fiberboard (Cobb test).

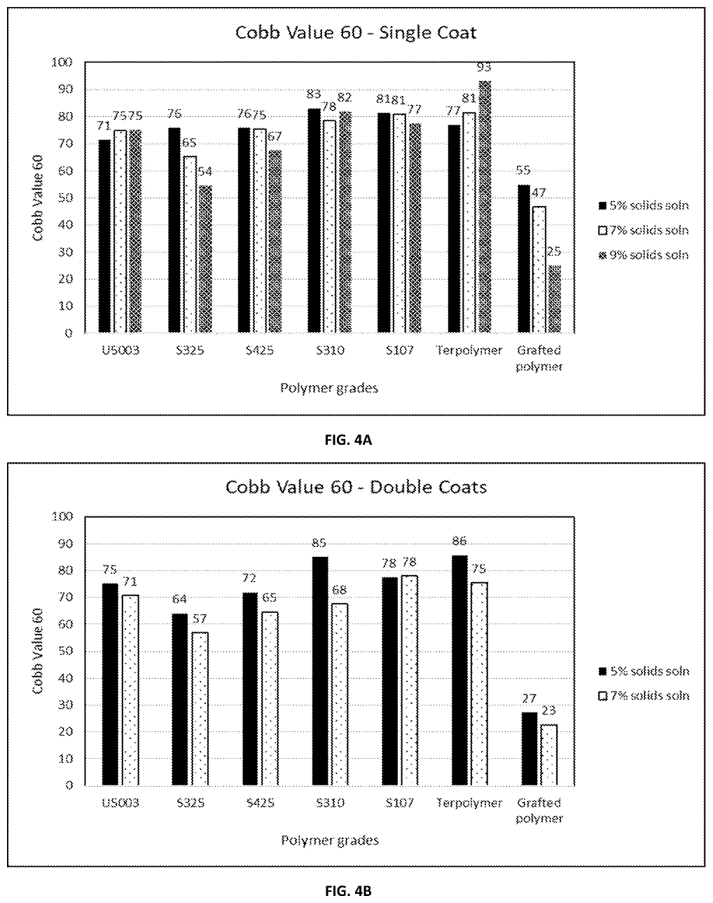

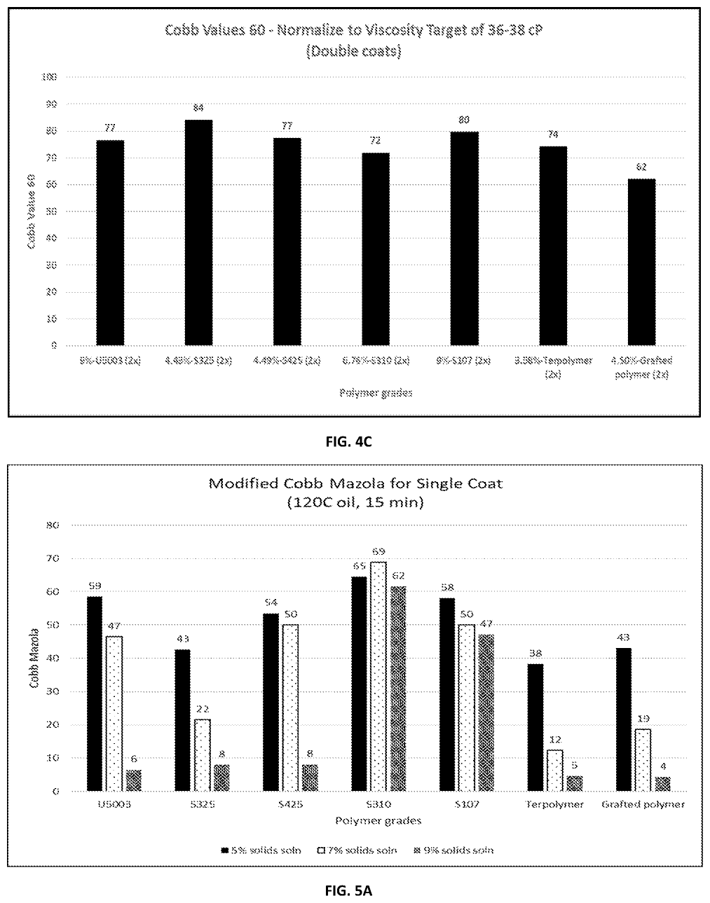

The results of the Cobb Test Method are shown with reference to FIGS. 4A, 4B and 4C. FIG. 4A shows the Cobb values for a single coating of the terpolymer sample and comparative formulations with varying solution solids contents of 5%, 7%, and 9%, whereas FIG. 4B shows the Cobb values for a double coating targeted to a coat weight of about 2 to about 5 gsm. FIG. 4C shows the results of Cobb value measurements on the samples and comparative examples where the double coat formulations have been normalized to a viscosity target of 36-38 cP by adjusting solution solids, which are listed next to each sample name along the x axis of the figure. For the Cobb Test Method, lower values are typically better, which means less water absorptiveness, however, the desired performance is application dependent. Cobb values greater than 60 indicate saturation and bleed-through of water, which is not desirable for food paper packaging applications, for example.

As can be seen in FIG. 4A, even a single coat at all solution solids of the grafted terpolymer sample showed Cobb values lower than 60 versus the terpolymer alone or the comparative commercial PVOH resins. A double coat targeted to coat weight of about 2 to about 5 gsm, as shown in FIG. 4B, improved the performance even further with much lower Cobb values. Lastly, for the double coat, even when normalized for a viscosity target of 36-38 cP, the grafted terpolymer showed better performance than the terpolymer alone and the commercial comparative examples.

Accordingly, the PVOH terpolymers and grafted terpolymers of the present disclosure may have a water absorptiveness value that is customizable between 0-100%, preferably about 0 to about 50%, most preferably between about 0 to about 20% according to the Cobb Test Method when normalized to a solution viscosity of about 36 to about 38 cP and a coat weight of about 2 to about 5 gsm.

### Cobb/Mazola—Oil and Grease Resistance

Coating solutions of the terpolymer and grafted terpolymer samples and comparative commercial samples described above were measured using the Cobb/Mazola Test Method to assess oil and great resistance. A water absorption apparatus, made by TMI model 61-04 Cobb Sizing Tester was used for the test method, which is described as follows according to TAPPI T 441, Water absorptiveness of sized (non-bibulous) paper, paperboard, and corrugated fiberboard (Cobb test). The test utilized a 10 square centimeter cylinder and 10 ml of 120° C. heated corn oil. Test was performed in an oven set at 120° C. oven for a duration of 15 minutes.

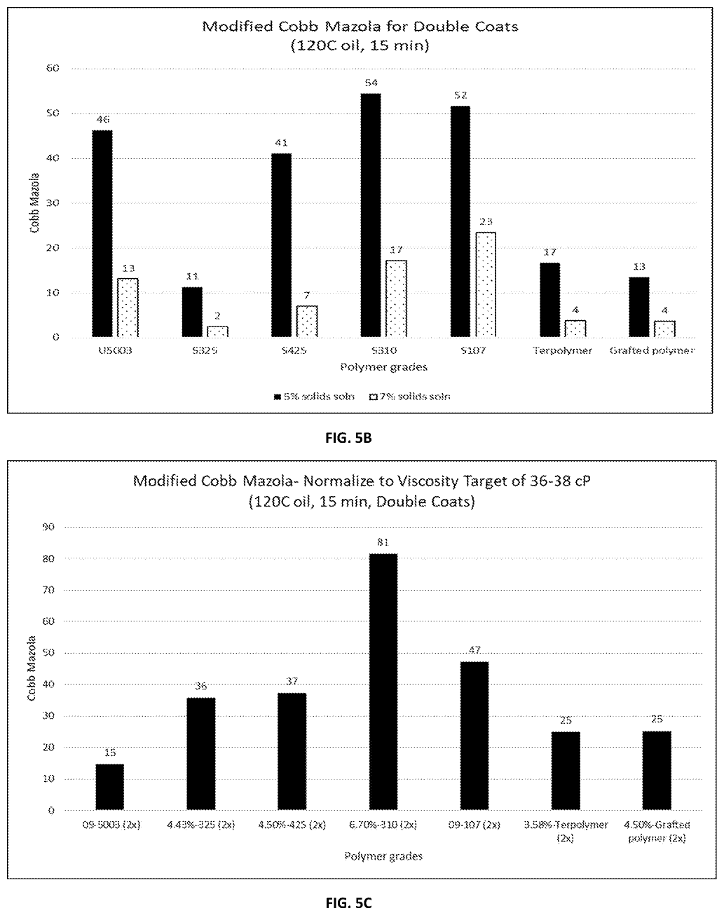

The results of the Cobb/Mazola Test Method are shown with reference to FIGS. 5A, 5B and 5C. FIG. 5A shows the Cobb/Mazola values for a single coating of the terpolymer sample and comparative formulations with varying solution solids contents of 5%, 7%, and 9%, whereas FIG. 5B shows the values for a double coating targeted to coat weight of about 2 to about 5 gsm. FIG. 5C shows the results of Cobb/Mazola Test Method measurements on the samples and comparative examples where the formulations have been normalized to a viscosity target of 36-38 cP by adjusting solution solids for the double coating, which are listed next to each sample name along the x axis of the figure. For the Cobb/Mazola Test Method, lower values of less than 8 are typically better such as for food packaging applications, which means some to no oil staining of the cellulosic materials tested, however, the desired performance is application dependent.

As shown in FIGS. 5A-5C, the terpolymer as well as the grafted terpolymer tended to perform better compared to most of the comparative commercial samples, except for U5003 (the PVOH/Vinyl Amine Copolymer) in the single wet coat (FIG. 5A) and double-coat viscosity normalized (FIG. 5C) data.

Accordingly, the PVOH terpolymers and grafted terpolymers of the present disclosure may have oil and grease resistance value that is customizable between 0-100%, preferably about 0 to about 50%, most preferably between about 0 to about 10% according to the Cobb/Mazola Test Method when normalized to a solution viscosity of about 36 to about 38 cP and a coat weight of about 2 to about 5 gsm.

### 3M Test Kit—Grease Resistance

Coating solutions of the terpolymer and grafted terpolymer samples and comparative commercial samples described above were measured using the 3M Kit Test Method to assess grease resistance values. A panel of test solutions with varying strengths of castor oil, toluene, heptane and turpentine were used for the test method, which is described as follows according to TAPPI T 559, Grease resistance test for paper and paperboard.

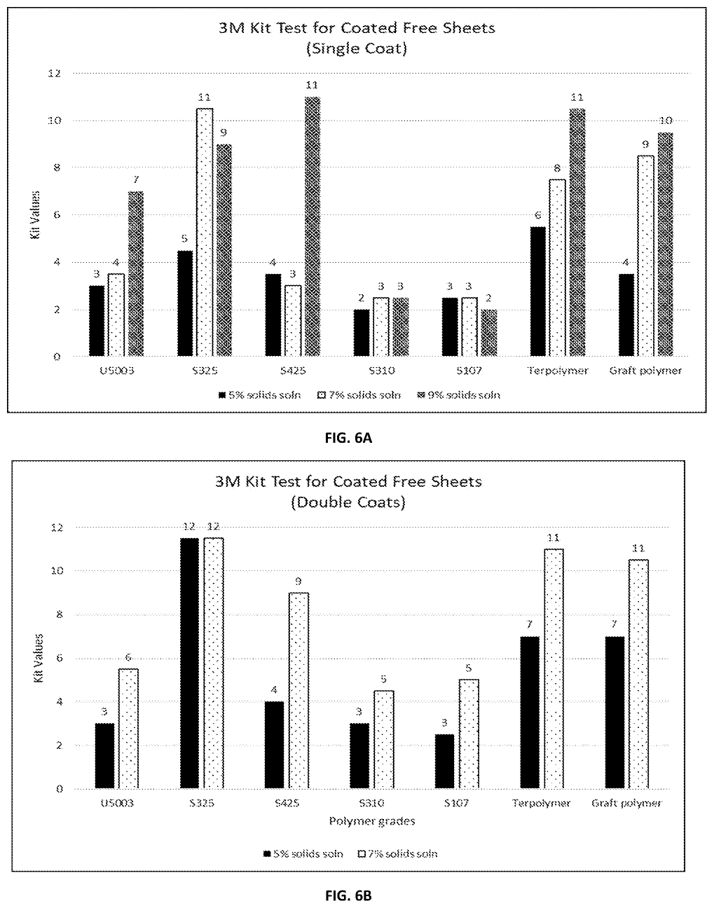

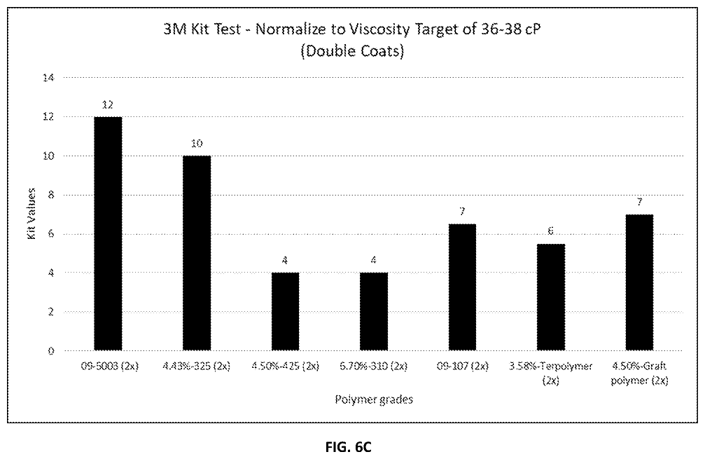

The results of the 3M Kit Test Method are shown with reference to FIGS. 6A, 6B and 6C. FIG. 6A shows the 3M Kit values for a single coating of the terpolymer sample and comparative formulations with varying solution solids contents of 5%, 7%, and 9%, whereas FIG. 6B shows the values for a double coating. FIG. 6C shows the results of the 3M Kit measurements on the samples and comparative examples where the formulations have been normalized to a viscosity target of 36-38 cP by adjusting solution solids for the double-coat, which are listed next to each sample name along the x axis of the figure. For the 3M Kit Test Method, the values range on a scale from 1-12, with higher values typically desired for most applications.

As shown in FIGS. 6A-6C, the terpolymer as well as the grafted terpolymer samples had suitable though not always improved performance compared with some of the commercial examples.

Accordingly, the PVOH terpolymers and grafted terpolymers of the present disclosure may have a grease resistance value that is customizable between 0-12, preferably about 1 to about 12, most preferably between about 3 to about 12 according to the 3M Kit Test Method when normalized to a solution viscosity of about 36 to about 38 cP and a coat weight of about 2 to about 5 gsm.

All of the above tests were also performed on the samples of Terpolymer 1 and Terpolymer 2, and Grafted Terpolymer 1 and Grafted Terpolymer 2 of TABLES 1 and 2, respectively, and the results were consistent with what was observed for Terpolymer 3 and Grafted Terpolymer 3 testing described above.

The results above show that the sample polyvinyl alcohol terpolymers possess both good moisture resistance as well as oil and great resistance, which are typically mutually exclusive properties for water-soluble PVOH resins, and that this performance is even further enhanced when the terpolymer is grafted to a sizing agent. Further, hydrophilic comonomers that are highly water soluble, including but not limited to sulfonic acid monomers, are not typically chosen for cellulosic material coatings and formulations. Although sizing agents such as AKD or ASA are commonly used in the paper industry, they are traditionally used as an internal sizing agents formulated into the paper composition itself. Further, high quantities of sizing agent are typically needed to achieve the requisite levels of hydrophobicity needed by food packaging and other applications unless fluorocarbons are included. The downside is that high levels of sizing agent causes paper processing issues, including stickiness on rollers, etc, and thus a solution to fluorocarbon-free formulations has thus far eluded the industry.

It was not obvious to base a cellulosic materials formulation on highly hydrophilic PVOH comonomers such as sulfonic acid based monomers. To offset the hydrophilic issue, PVOH was formulated to add a hydrophobic comonomer as described herein. However, for some applications and needs, polyvinyl alcohol terpolymers having both a hydrophilic comonomer and a hydrophobic comonomer are not sufficient, but it was surprisingly found that performance could be further enhanced by grafting a sizing agent directly to the terpolymer, the sizing agent also being hydrophobic.

It is difficult to achieve a balance between sufficient hydrophobicity and solubility for making coatings or other cellulosic material solutions. Regular PVOH homopolymers grafted with sizing agents, or hydrophilic PVOH copolymers such as sulfonic acid modified copolymers grafted with sizing agents, were found to not be phase stable as a solution. It was surprisingly found that the terpolymers and grafted terpolymers of the embodiments described herein possessed phase stability, thus making them practical for formulating as coatings or other uses in cellulosic material industries. This is due in part to the particular mol % or loading of each of the hydrophilic and hydrophobic comonomers when synthesizing the terpolymer, as well as the mol % of the sizing agent in the case of the grafted terpolymer. Further, when making new terpolymers such as described herein, there is the possibility that undesirable crosslinking and reactivity may occur with new molecules such as AKD being introduced, thus it was surprising that a sizing agent such as AKD could be directly grafted to the terpolymer and achieve good performance.

While the invention has been described with reference to exemplary embodiment(s), it will be understood by those skilled in the art that various changes may be made, and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. A formulation for cellulosic materials comprising:
a polyvinyl alcohol terpolymer comprising a polyvinyl alcohol modified with about 1 mol % to about 10 mol % of a hydrophilic comonomer, and with about 1 mol % to about 5 mol % of a hydrophobic comonomer, and having a degree of hydrolysis of about 92% to about 98%.

2. The formulation for cellulosic materials of claim 1, wherein the polyvinyl alcohol terpolymer is grafted to about 0.25 mol % to about 2.0 mol % of a sizing agent equivalent to mol % of terpolymer.

3. The formulation for cellulosic materials of claim 1 or 2, wherein the polyvinyl alcohol terpolymer comprises one or more hydrophilic comonomers selected from the group consisting of sulfonic acid, vinyl lactam, carboxylate, vinyl amine, and vinyl amide.

4. The formulation for cellulosic materials of any one of claims 1 to 3, wherein the hydrophilic comonomer comprises 2-acrylamido-2-methylpropanesulfonic acid.

5. The formulation for cellulosic materials of claim 4, comprising about 2 mol % to about 6 mol % of the 2-acrylamido-2-methylpropanesulfonic acid.

6. The formulation for cellulosic materials of any one of claims 1 to 5, wherein the hydrophilic comonomer comprises N-vinyl-2-pyrrolidone.

7. The formulation for cellulosic materials of claim 6, comprising 2 mol % to about 6 mol % of the N-vinyl-2-pyrrolidone.

8. The formulation for cellulosic materials of any one of claims 1 to 7, wherein the hydrophilic comonomer comprises itaconic acid.

9. The formulation for cellulosic materials of claim 8, comprising about 1 mol % to about 4 mol % mol % of the itaconic acid.

10. The formulation for cellulosic materials of any one of claims 1 to 9, wherein the hydrophobic comonomer comprises a vinyl ester of a branched tertiary monocarboxylic acid.

11. The formulation for cellulosic materials of any one of claims 1 to 10, wherein the hydrophobic comonomer comprises a vinyl ester of versatic acid.

12. The formulation for cellulosic materials of any one of claims 1 to 11, wherein the hydrophobic comonomer comprises vinyl neodecanoate or vinyl neononanoate.

13. The formulation for cellulosic materials of claim 12, comprising about 1 mol % to about 4 mol % of the vinyl neodecanoate or vinyl neononanoate.

14. The formulation for cellulosic materials of any one of claims 1 to 13, wherein the sizing agent comprises an alkyl ketene dimer.

15. The formulation for cellulosic materials of any one of claims 1 to 13, wherein the sizing agent comprises an alkenyl succinic anhydride.

16. The formulation for cellulosic materials of any one of claims 1 to 15, comprising a solution viscosity of between about 4 to about 800 cP.

17. The formulation for cellulosic materials of any one of claims 1 to 16, comprising a porosity value of about 10 to about 500,000 according to the Gurley Densometer Test Method when normalized to a solution viscosity of about 36 to about 38 cP and a coat weight of about 2 to about 5 gsm.

18. The formulation for cellulosic materials of any one of claims 1 to 17, comprising a water absorptiveness value of about 0% to about 50% according to the Cobb Test Method when normalized to a solution viscosity of about 36 to about 38 cP and a coat weight of about 2 to about 5 gsm.

19. The formulation for cellulosic materials of any one of claims 1 to 18, comprising an oil and great resistance value of about 0% to about 50% according to the Cobb/Mazola Test Method when normalized to a solution viscosity of about 36 to about 38 cP and a coat weight of about 2 to about 5 gsm.

20. The formulation for cellulosic materials of any one of claims 1 to 19, comprising a grease resistance value of 1 to 12 according to the 3M Kit Test Method when normalized to a solution viscosity of about 36 to about 38 cP and a coat weight of about 2 to about 5 gsm.
